(19) United States
(12) Patent Application Publication
(10) Pub. No.: US 2005/0276612 A1
(43) Pub. Date: Dec. 15, 2005

(54) Opto-electronic module

(76) Inventors: Debra Wawro, Paradise, TX (US); Muneer Zuhdi, Lewisville, TX (US)

Correspondence Address: BAKER BOTTS L.L.P., 2001 ROSS AVENUE, 6TH FLOOR, DALLAS, TX, 75201, US

(21) Appl. No.: 10/867,092

(22) Filed: Jun. 14, 2004

(51) Int. Cl. H04B 10/00

(52) U.S. Cl. 398/164

(57) ABSTRACT

An opto-electronic module has a platform and an optical sub-unit. The platform has a trough structure defined on a surface of the platform and the trough structure is configured to transmit an optical beam through the trough structure. The electrical sub-unit is coupled to the trough structure. The sub-unit is configured to mate with the trough structure to provide a chosen alignment to emit, operate on or receive the optical beam.

### FIELD

This technology relates to fiber-to-the-home applications. In particular, the technology concerns an opto-electronic module for use in fiber-to-the-home applications, among other applications

### BACKGROUND

Fiber-to-the-home (FTTH) architecture involves fiber deployment to a customer's home and is a means for providing high-speed data, dependable voice service, and high-quality video. One issue in current FTTH designs is cost. Low cost systems are preferred and necessary for the ultimate implementation of FTTH architecture. The opto-electronic module is one component of the FTTH architecture that drives costs.

Construction of opto-electronic modules typically requires assembly techniques that provide alignment of waveguide components with other components in the module, all within the confines of a modular construction. Current constructions of opto-electronic modules require alignment of the components to positional tolerances within tenths of microns. This level of precision requires specialized techniques, such as laser welding or corrective optical elements. In addition, once aligned and secured, these assemblies must remain stable throughout the modules lifetime and during environmental stressing. For low cost packaging, this is difficult to accomplish.

### SUMMARY

In accordance with the teachings described herein, an opto-electronic module comprises a platform having a trough structure and a sub-unit coupled to the trough structure. The trough structure is defined on a surface of the platform and is configured for the transmission of an optical beam through the trough structure. The sub-unit has a surface that is configured to mate with the trough structure to provide a chosen alignment on the platform in order to emit, operate on, or receive the optical beam.

The sub-unit may comprise a plurality of sub-units, each of which is coupled to the trough structure for transmitting, operating on, or receiving the optical beam. The sub-units may include a submount having a lower surface and the lower surface has a protrusion with a contour. The trough structure also has a contour that is configured to precisely mate with the contour of the protrusion. The module may further comprise at least one recess for accepting a joining member of a sub-unit. The joining member may be an electrical contact.

The trough structure may have side walls that are sloped at an angle, and the protrusions may have side walls that are sloped at an angle that is complementary to the angle of the trough structure side walls. The sub-units may include a plurality of electrical contacts. The platform may include a plurality of recesses for accepting the plurality of electrical contacts from the sub-units. The plurality of recesses and contacts are precisely positioned to provide the chosen alignment. A recess may be defined on the platform for accepting a filter. The platform surface may be flat and the trough structure may have a bottom surface that is flat.

The sub-unit may include a submount having a lower surface and the lower surface may have a protrusion with a contour. The platform surface is flat and the submount lower surface is flat, other than the protrusion. The sub-unit may comprise a plurality of sub-units, and the plurality of sub-units may comprise a laser diode, an attachable optical fiber connector, and at least one photodiode. The at least one photodiode may comprise a photodetector chip, a lens, a submount, and a cap. The device may also include an optical filter associated with the photodiode, with the cap being for alignment of the filter on the submount. The photodiode is preferably configured to receive a signal at at least one wavelength from an optical beam.

The attachable optical fiber connector comprises a submount, a decollimating unit, and a fiber, with the fiber fixedly coupled to the submount. The attachable optical fiber connector may alternatively comprise a connector, a decollimating unit, and a fiber, with the fiber fixedly coupled to the connector, and the connector having a contour for seating in the trough structure.

The platform may be silicon. Alternatively, the platform may comprise a base portion and an insert, with the trough structure being defined in the insert. The base portion may be plastic and the insert may be silicon.

In another embodiment, an opto-electronic module comprises a platform and a plurality of sub-units. The platform has a trough structure defined on a surface thereof and the trough structure is configured for the transmission of an optical beam. The plurality of sub-units is coupled to the platform. The sub-units are configured to emit, operate on or receive the optical beam. The platform and plurality of sub-units are together configured to provide angular alignment of the sub-units on the platform in both a vertical plane and a horizontal plane for the transmission of an optical beam between the plurality of sub-units.

Each of the plurality of sub-units may have at least one protrusion and the protrusions may be configured to precisely seat in the trough structure to couple the plurality of sub-units to the platform. The platform may include recesses and the sub-units may include members for seating in the recesses, with both the trough structure and the recesses being utilized for coupling the sub-units to the platform and for aligning the sub-units on the platform.

The plurality of sub-units comprise at least one optical component. The at least one optical component comprises a laser diode, a fiber connector, a filter, and a photodiode. The plurality of sub-units may also include at least one electrical component. The at least one electrical component may comprise a chip.

In yet another embodiment, a module for converting a collimated beam of light into an electrical signal comprises a substrate and a plurality of optical components. The substrate has a recessed path for transmitting a collimated beam of light. The optical components are associated with the recessed path for emitting, operating on, or receiving the collimated beam of light to convert a beam of light to an electrical signal or convert an electrical signal to a beam of light. At least one electrical component may also be associated with the substrate. The plurality of optical components may comprise a laser diode, a fiber connector, at least one photodiode, and at least one filter, and the at least one electrical component may comprise a laser driver chip.

### BRIEF DESCRIPTION OF THE DRAWING FIGURES

FIG. 1 is an elevated perspective illustration of an example modular microbench;

FIG. 2 is a plan view of the example modular microbench like that of FIG. 1, without a cover installed;

FIG. 3 is a top exploded perspective view of the example microbench of FIG. 2;

FIG. 4 is a bottom exploded perspective view of the example microbench of FIG. 2;

FIG. 5 is an exploded perspective view of an alternative embodiment of the example microbench;

FIG. 6 is a perspective view of the microbench of FIG. 5 with a cover installed on the platform;

FIG. 7 is an exploded perspective illustration of a photodiode sub-unit of the microbench; and

FIG. 8 is a cross-sectional view of a sub-unit installed in an example microbench.

### DETAILED DESCRIPTION

With reference now to the drawings, the example opto-electronic device 10 is utilized to convert a fiber optical signal to an electrical signal. The example device 10 comprises a module of individual sub-units 12, which can either emit, operate on, or receive a collimated laser beam of light. The collimated beam of light carries a signal at one or more wavelengths. This signal may be in the form of voice, video, data, or otherwise. The opto-electronic device 10 takes incoming light energy and separates it into separate wavelengths, where more than one wavelength of energy is present. The device 10 also takes electrical signals and converts them to a beam of light in order to transmit a signal from a user's house. The sub-units 12 are optically interconnected to other sub-units 12 by the collimated beams. The interconnecting beams of light are less sensitive to alignment tolerances normal to the beam. As a result, the example opto-electronic device 10 may be assembled with techniques that do not require the precise positioning of prior art assemblies.

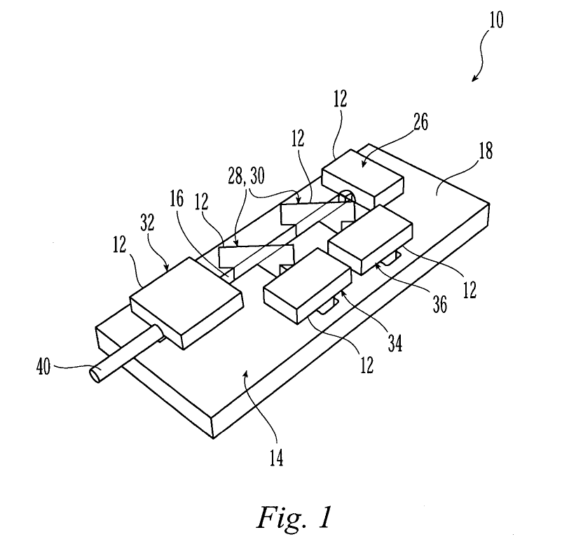

FIGS. 1-4 illustrate an embodiment of an example opto-electronic modular microbench 10. The microbench 10 includes a platform 14 that has trough structure in the form of a series of joined troughs 16 formed on an upper surface 18 of the platform 14. Several optical sub-units 12 are positioned on the upper surface 18 of the platform 14 in the troughs 16. Each sub-unit 12 includes a submount that has a protrusion 20 that extends downwardly from the submount. Each protrusion 20 is sized to accurately fit in the trough structure 16. In one embodiment, the protrusions 20 have sloping side surfaces 22 that contact sloping walls 24 of the trough structure 16 in order to obtain precision placement.

The sub-units 12 depicted in FIGS. 1-4 include a laser diode sub-unit 26, a first optical filter 28, a second optical filter 30, an attachable optical fiber connector 32, a first photodiode sub-unit 34, and a second photodiode sub-unit 36. Electrical components may also be integrated on the platform 14. For example, a laser driver chip (not shown) may be integrated into the microbench 10 in the vicinity of the laser diode sub-unit 26. A voltage is applied to the laser driver chip, which in turn provides an electrical current to the laser diode 26. The laser diode 26 converts the electrical current into optical power. Integrating the laser driver chip into the microbench 10 provides a strong and clean beam of light from the laser diode 26. The laser diode 26 includes a submount 27 that has a protrusion 20 extending downwardly from the submount 27. The submount 27 has a flat lower surface for mating with the flat upper surface 18 of the platform 14, and the protrusion 20 extends downwardly from the flat lower surface.

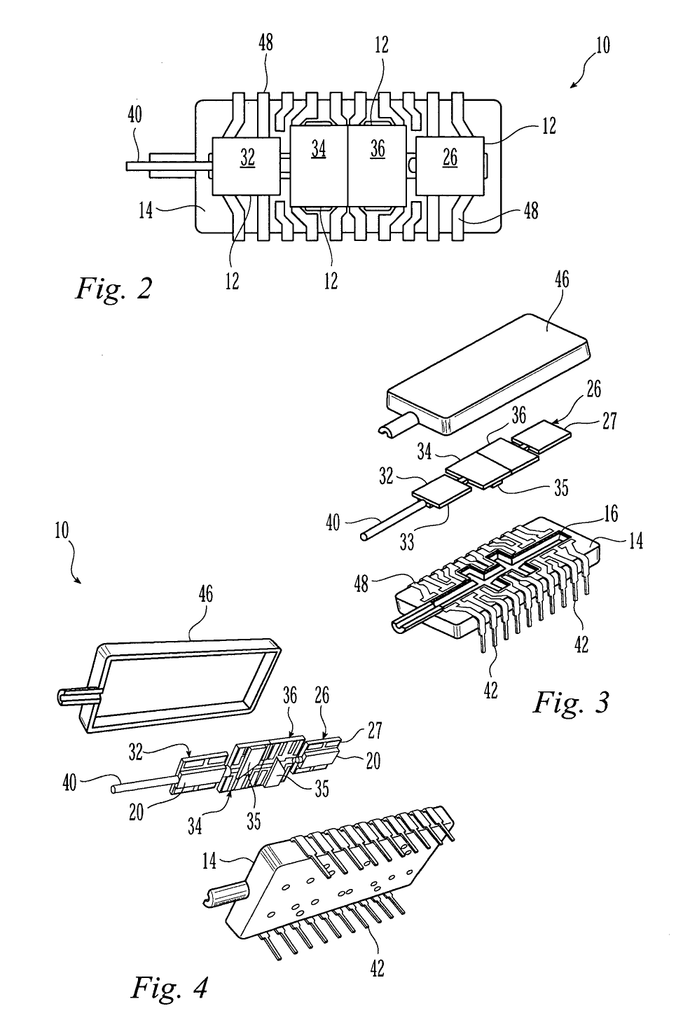

The filters 28, 30 are beamsplitters and the photodiodes 34, 36 are receivers. Although separate components, the first optical filter 28 is typically packaged with the first photodiode sub-unit 34 and the second optical filter 30 is typically packaged with the second photodiode sub-unit 36. In particular, each package includes an alignment cap 38 that covers both the photodiode 34, 36 and the associated filter 28, 30, and the photodiode submount 35. In the embodiment of FIG. 1, the first optical filter 28 is shown angled in a similar manner as the second optical filter 30 for communication with the photodiodes 34, 36, which are positioned adjacent one another on the same side of the platform 14. In an alternative embodiment, shown in FIGS. 2-4, the first filter 28 may be angled in an opposite direction to the second filter 30, and the photodiodes 34, 36 are positioned on opposite sides of the platform 14. Other electrical or optical modules may also be positioned on the platform 14, if desired.

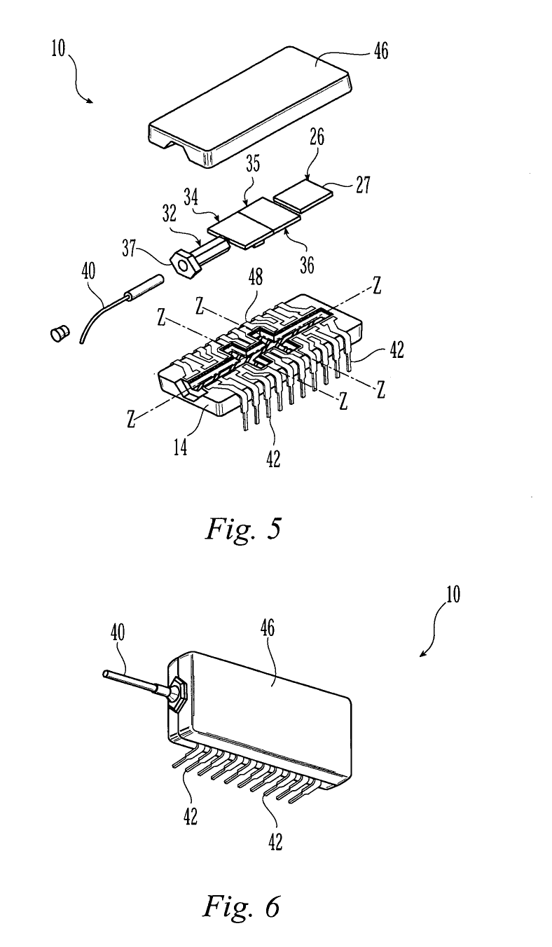

The attachable fiber connector sub-unit 32 is connected to a fiber optic cable 40. The fiber sub-unit 12 may include a submount 33, as shown in FIGS. 2-4, that has a connection for mating with the fiber and for housing a decollimating unit. The submount 33 preferably has a flat lower surface for mating with the flat upper surface 18 of the platform 14 and includes the protrusion 20 that extends downwardly from the lower surface. Alternatively, the fiber submount 33 may include a connector 37, as shown in FIG. 5, for receiving the fiber. The connector 37 has a surface for mating with the trough structure 16 of the platform 14. A decollimating unit may also be associated with the connector 37. The fiber 40 may be inserted into or attached to the sub-unit 32 as one of the final steps in the assembly process of the microbench 10 in order to improve quality by avoiding the possibility of breaking or burning the fiber 40, which frequently occurred in prior art soldering processes.

FIGS. 2-6 depict the microbench 10 as including a series of electrical contacts 42 that extend downwardly along the sides of the platform 14 from the upper surface 18 of the platform 14. These contacts 42 are coupled to the sub-units 12 that are positioned in the troughs 16. The electrical contacts 42 are configured to seat in recesses defined on a circuit board (not shown). The microbench 10 also includes a top cover 46 that is configured to snap onto the platform 14 over the sub-units 12. The top cover 46 serves to protect the sub-units 12 on the platform 14 and to package the microbench 10 into a modular unit, as shown best in FIG. 6. The combination of parts provides a modular design that is easily insertable into openings on a circuit board. Electrical contacts 48 are utilized on the platform 14 to provide electrical power to the sub-units 12 and to transfer a signal to the circuit board. The electrical contacts 48 are wires that are bonded to the platform 14 and they extend to pins 42 that assist in mounting the opto-electronic module 10 to a circuit board. The electrical track structure includes electrical pads 50 that are positioned in the troughs 16. These electrical tracks connect the bonded sub-units to the outside pins 42 of the module 10. The outside pins 42 are utilized to connect the module 10 to a circuit board. Other types of electrical contacts may alternatively be used.

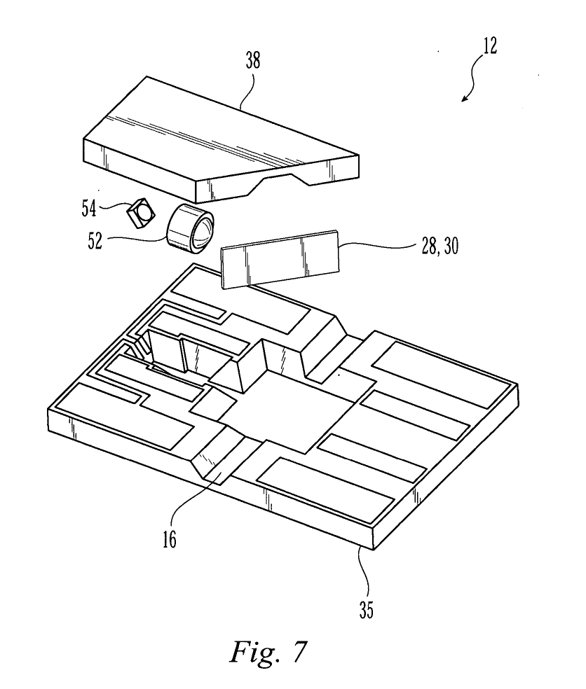

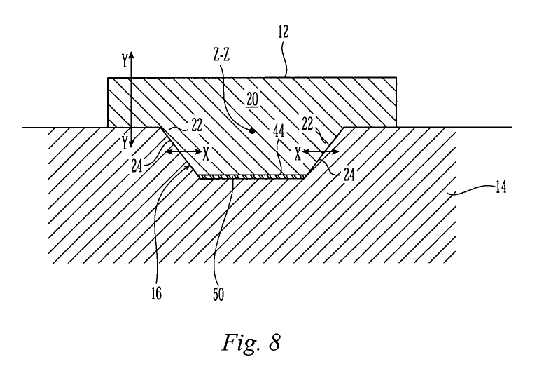

FIG. 7 depicts one embodiment of a photodiode sub-unit assembly 34, 36 packaged with a filter 28, 30. The photodiode assembly is utilized to convert the optical input power into an electrical current and includes a lens 52 and a photodetector chip 54. This assembly utilizes the microbench platform 14 and its associated electrical contacts 48 and trough structure 16 for accepting electrical and optical components. The optical components include the optical filter 28, 30 and the low cost lens 52. Electrical parts preferably include the photodetector chip 54. Both the optical and electrical parts are positioned on the photodiode submount 35. In addition, the submount 35, lens 52, filter 28, 30, and chip 54 are covered by an alignment cap 38. Each of the components are positioned in the troughs 16 and the alignment cap 38 is positioned over the chip 54, lens 52, filter 28, 30, and submount 35. The alignment cap 38 includes surfaces that match the position of the filter 28, 30 and the photodiode 34, 36. The cap 38 is utilized to maintain the alignment of the filter 28, 30 and photodiode 34, 36, once installed. In one embodiment, the cap 38 is rectangular, although it may take on other shapes. Positioning of the chip 54 on the photodiode sub-unit 34, 36 is beneficial because any noise that was present in prior systems is avoided. The lens 52 and filter 28, 30 may also be held in position by a light curing adhesive (not shown).

The lens 52 must be accurately positioned in the photodiode submount 35 and fixed in the two lateral planes normal to the optical axis Z-Z. Positioning of the lens 52 along the optical axis Z-Z is controlled by the placement of the lens 52 with respect to the edge of the submount 35. Contacting the lens 52 on this edge sets the focal distance. Alignment in the two lateral planes X-X, Y-Y normal to the optical axis Z-Z is accomplished by moving the lens 52 over the edge surface and registering the direction of the beam when the opto-electronic device is emitting. The lens 52 is fixed by a layer of light curing adhesive (not shown) and is cured when the correct alignment of the beams is achieved.

A trans-impedance amplifier (TIA) chip (not shown) is preferably coupled to the photodiode for receiving the electrical current from the photodiode, filtering noise out of the signal, and amplifying the signal. The signal coming from the photodiode is typically weak and noisy. Therefore, it is advantageous to locate the TIA as close as possible to the photodiode on the module. The microbench structure described herein makes the integration process of the TIA with the photodiode fairly easy and is fully automated due to the modular design of the microbench.

FIG. 8 depicts the protrusion 20 of the sub-unit 12 installed in a trough structure 16. The example microbench has a flat upper platform surface 18. Angular alignment is achieved in the vertical plane Y-Y by the flat upper surface 18 and inter-surface contacts between the flat surface of the platform 14 and the underside 56 of the sub-units 12. Angular alignment in the horizontal plane X-X is achieved by a precise engagement of the protrusion 20 for each sub-unit 12 into a preformed trough structure 16 within the platform 14. It is preferred that the joints between the flat upper surface 18 of the platform 14 and the protrusions 20 of the sub-units 12 have a consistent thickness in order to maintain angular alignment, but the actual thickness is of lesser importance. The sub-units 12 may be configured in any arrangement.

In a preferred embodiment, as shown in FIG. 8, the trough 16 has a truncated V-shape, with sloping side surfaces 24 and a flat base surface 44. The protrusions 20 on the sub-units 12 preferably have a complementary shape for seating snuggly within the trough structure 16. Alternative shapes for the troughs 16 and protrusions 20 may also be used, such as non-sloping side surfaces, curved surfaces or otherwise, among other configurations.

The trough structure 16 provides an avenue for the transmission of the collimating beam. In addition, the trough structure 16 provides a thermal path for more efficient heat dissipation and distribution than with prior art solutions. Heat will spread through the troughs 16 and travel directly to the external electrical leads 42. This design has a reduced tolerance to alignment in directions normal to the beam, but requires exact angular alignment.

The components on the microbench 10 operate together to receive information into the home and transmit information from the home. The incoming signal enters the microbench 10 from outside the home in the form of a collimated beam of light via the fiber optic cable 40, which is coupled to the attachable optical fiber connector sub-unit 32. The signal may be at a single wavelength, or multiple wavelengths. Optical energy travels from the fiber 40 through the trough structure 16 to the filters 28, 30. The filters 28, 30 are utilized to split the beam of light into different wavelength signals. For instance, a portion of the beam of light that includes voice and data may be included in a first wavelength signal while a portion of the beam of light that includes video may be included in a second wavelength signal. The light is split via the first and second filters 28, 30, which are angled relative to the beam of light. The filters 28, 30 allow some light to pass through and reflect the remainder in the desired wavelength. The first filter 28 directs the first wavelength to the first receiver (the first photodiode) 34 via the trough structure 16. The second filter 30 directs the second wavelength to the second receiver (the second photodiode) 36 via the trough structure 16. The reflected light is collected in the photodiodes 34, 36 and converted to an electrical signal for use in the home. The electrical signal is then transferred to a circuit board (not shown) that is coupled to the microbench 10 via the electrical connectors 42 positioned on the microbench 10.

For an outgoing signal that is leaving the home, information travels to the laser diode 26 as an electrical signal from the circuit board to the microbench 10 via electrical connectors 42 positioned on the microbench 10. The laser diode 26 and a laser driver chip together convert the electrical signal into an optical signal in the form of a collimated beam of light. This light travels through the trough structure 16 through the filters 28, 30 and is collected by the attachable optical fiber connector 32, which includes a decollimating unit that focus the light into the fiber 40. The signal leaves the microbench 10 through the fiber cable 40.

The example microbench 10 is for use in optical interface units (OIU's) that utilize two or three port optical devices, such as duplexers and triplexers, among other uses. The example depicted in FIGS. 1-4 is for use with a signal transmission that has two different wavelengths. As discussed above, the first wavelength could include, for example, voice and data while a second wavelength could include video. Voice and data may be at a wavelength of about 1480 to 1500 nanometers while the video signal may be at a wavelength between 1540 and 1560 nanometers. Additional filters and photodiodes may be utilized where more than two wavelengths of the digital signal are present in the incoming data stream. One filter is typically provided for each wavelength of the signal.

Assembly of the system requires the placement of sub-units 12 into their respective positions and a fix procedure involving a straight forward bond with a joining material, such as a solder or an epoxy. The joining material may also act as an electrical interconnect.

The trough structure 16 in the platform 14 may be formed in a number of different ways. The platform 16 and troughs 16 may be formed integrally during a molding process, such as injection molding. The electrical lead structures 42, 48, 50 can be incorporated directly into the platform 14 during the molding process. The platform 14 and trough structure 16 may be integrally formed from a plastic or silicon material, among other materials. The platform 14 may be formed of a plastic material and a silicon layer can be applied to the troughs 16, if desired. In another embodiment, the troughs 16 may be formed as a separate insert by a precision photolithographic process, and the insert may then be embedded in the platform structure 14 by standard insert molding processes. The troughs 16 may be formed of a first material, such as silicon, and the platform 14 may be formed of a second material, such as plastic. The use of a different trough material can add to the mechanical stability of the platform structure 14, and offer a precision trough structure 16 for accepting the sub-units 12.

The use of a trough structure 16 offers a trough with sloping walls 24 for alignment of the sub-units 12 when they are lowered into the trough 16. This offers a larger placement target for assembly and simplifies the process. Final angular alignment in the horizontal plane occurs when the protrusion 20 enters the trough 16 and engages against the side walls 24. The joining material provides the down force necessary to maintain the alignment of the sub-units 12 in the trough 16. The system provides a basis for many different configurations for opto-electronic pathways. Other designs for the protrusions 20 and troughs 16 may be utilized.

The example microbench 10 can be used for either duplexer or triplexer architecture. First stage amplification for the digital and/or analog receiver can be integrated into the design. The microbench 10 is surface mountable, e.g., mountable directly on a circuit board. This is advantageous because the present design does not require that any parts extend through the circuit board, as with prior devices, such as with the Triport BIDI®. This improves the performance on the circuit board and makes the assembly process easier and less expensive.

The assembly is preferably designed for operation at a temperature range of −40 C to 85 C and is mass producible using standard chip placement machines, such as pick-and-drop machines. Because the production process may be automated, the assembly provides a reduced package size at a lower cost than current designs, and has a high performance level of 2.5 Gbps. The system provides a basis for many different configurations of opto-electronic pathways.

The example architecture allows the direct integration of monolithic or chip level electronic circuitry, such as laser drivers and receiver circuitry. It is low cost and highly integratable. While the above-described embodiments are discussed in the context of FTTH applications, the example microbench 10 has applications in many areas of telecommunications, including long-haul, metro, and access markets. It can be utilized in dense wavelength division multiplexing (DWDM), wavelength division multiplexing (WDM) (dual wavelength), and single wavelength applications where high performance, low cost opto-electronic devices are utilized.

The term “flat”, as used herein, means flat or substantially flat, where substantially is used as an estimation term.

While various features of the claimed embodiments are presented above, it should be understood that the features may be used singly or in any combination thereof. Therefore, the claimed embodiments are not to be limited to only the specific embodiments depicted herein.

Further, it should be understood that variations and modifications may occur to those skilled in the art to which the claimed embodiments pertain. The embodiments described herein are exemplary. The disclosure may enable those skilled in the art to make and use embodiments having alternative elements that likewise correspond to the elements recited in the claims. The intended scope may thus include other embodiments that do not differ or that insubstantially differ from the literal language of the claims. The scope of the example embodiments is accordingly defined as set forth in the appended claims.

1. An opto-electronic module comprising:
a platform having a trough structure defined on a surface of the platform, the trough structure configured for the transmission of an optical beam therethrough; and
a sub-unit coupled to the trough structure, said sub-unit having a surface that is configured to mate with the trough structure to provide a chosen alignment of the sub-unit on the platform to emit, operate on, or receive the optical beam.

2. The opto-electronic module of claim 1, wherein the sub-unit comprises a plurality of sub-units, each of which is coupled to the trough structure for transmitting, operating on, or receiving the optical beam.

3. The opto-electronic module of claim 1, wherein the sub-unit includes a submount having a lower surface and the lower surface has a protrusion with a contour, and the trough structure has a contour that is configured to precisely mate with the contour of the protrusion.

4. The opto-electronic module of claim 3, further comprising at least one recess for accepting a joining member of a sub-unit.

5. The opto-electronic module of claim 4, wherein the joining member is an electrical contact.

6. The opto-electronic module of claim 3, wherein the trough structure has side walls that are sloped at an angle, and the protrusions have side walls that are sloped at an angle that is complementary to the angle of the trough structure side walls.

7. The opto-electronic module of claim 3, wherein the sub-unit includes a plurality of electrical contracts, and further comprising a plurality of recesses defined on the platform for accepting the plurality of electrical contacts from the sub-unit, said plurality of recesses and plurality of electrical contacts being precisely positioned to provide the chosen alignment.

8. The opto-electronic module of claim 1, further comprising a recess on the platform for accepting a filter.

9. The opto-electronic module of claim 1, wherein the platform surface is flat and the trough structure has a bottom surface that is flat.

10. The opto-electronic module of claim 1, wherein the sub-unit includes a submount having a lower surface and the lower surface has a protrusion with a contour, the platform surface is flat and the submount lower surface is flat.

11. The opto-electronic module of claim 1, wherein the sub-unit comprises a plurality of sub-units, and the plurality of sub-units comprise a laser diode, an attachable optical fiber connector, and at least one photodiode.

12. The opto-electronic module of claim 11, wherein the photodiode comprises a photodetector chip, a lens, a submount, and a cap.

13. The opto-electronic module of claim 12, further comprising an optical filter associated with the at least one photodiode, with the cap being for alignment of at least the filter on the submount.

14. The opto-electronic module of claim 13, wherein the at least one photodiode is configured to receive a signal at at least one wavelength from an optical beam.

15. The opto-electronic module of claim 11, wherein the attachable optical fiber connector comprises a submount, a decollimating unit, and a fiber, with the fiber fixedly coupled to the submount.

16. The opto-electronic module of claim 11, wherein the attachable optical fiber connector comprises a connector, a decollimating unit, and a fiber, with the fiber fixedly coupled to the connector, and the connector having a contour for seating in the trough structure.

17. The opto-electronic module of claim 1, wherein the platform is silicon.

18. The opto-electronic module of claim 1, wherein the platform comprises a base portion and an insert, with the trough structure being defined in the insert.

19. The opto-electronic module of claim 16, wherein the base portion is plastic and the insert is silicon.

20. An opto-electronic module comprising:
a platform having a trough structure defined on a surface thereof, said trough structure configured for the transmission of an optical beam; and
a plurality of sub-units coupled to the platform, said sub-units configured to emit, operate on or receive the optical beam, wherein the platform and plurality of sub-units are together configured to provide angular alignment of the sub-units on the platform in both a vertical plane and a horizontal plane for the transmission of an optical beam between the plurality of sub-units.

21. The opto-electronic module of claim 20, wherein each of the plurality of sub-units has at least one protrusion and the protrusions are configured to precisely seat in the trough structure to couple the plurality of sub-units to the platform.

22. The opto-electronic module of claim 20, wherein the platform includes recesses and the sub-units include members for seating in the recesses, with both the trough structure and the recesses being utilized for coupling the sub-units to the platform and for aligning the sub-units on the platform.

23. The opto-electronic module of claim 20, wherein the plurality of sub-units comprises at least one optical component.

24. The opto-electronic module of claim 23, wherein the at least one optical component comprises a laser diode, a fiber connector, a filter, and a photodiode.

25. The opto-electronic module of claim 24, further comprising at least one electrical component.

26. The opto-electronic module of claim 25, wherein the at least one electrical component comprises a chip.

27. A module for converting a collimated beam of light into an electrical signal comprising:
a substrate having a recessed path for transmitting a collimated beam of light; and
a plurality of optical components associated with the recessed path for emitting, operating on, or receiving the collimated beam of light to convert a beam of light to an electrical signal or convert an electrical signal to a beam of light.

28. The module of claim 27, further comprising at least one electrical component associated with the substrate.

29. The module of claim 28, wherein the plurality of optical components comprises a laser diode, a fiber connector, at least one photodiode, and at least one filter, and the at least one electrical component comprises a laser driver chip.
